(19) United States
(12) Patent Application Publication
(10) Pub. No.: US 2007/0141533 A1
(43) Pub. Date: Jun. 21, 2007

(54) Polymeric dental implant assembly

(76) Inventors: Christopher W. Ford, Holly, MI (US); Boney A. Mathew, Clarkston, MI (US)

Correspondence Address: HARNESS, DICKEY & PIERCE, P.L.C., P.O. BOX 828, BLOOMFIELD HILLS, MI, 48303, US

(21) Appl. No.: 11/313,195

(22) Filed: Dec. 20, 2005

(51) Int. Cl. A61C 8/00

(52) U.S. Cl. 433/201.1

(57) ABSTRACT

A dental implant assembly that can be attached to a bone of a person. The implant assembly includes an anchor adapted for attachment to the bone. The anchor is also adapted for attachment to a tooth-replacing device. The anchor is at least partially made out of a polymeric material.

### FIELD OF THE INVENTION

The present invention relates to a dental implant and more particularly relates to a polymeric dental implant assembly.

### BACKGROUND OF THE INVENTION

Dental implants of numerous and varying designs have existed for many years. Many prior art dental implants include artificial teeth that are attached inside a patient's mouth to replace lost teeth and to restore natural dental function.

Although prior art dental implants have worked for their intended purpose, some disadvantages remain. For instance, conventional dental implants are typically made of ceramics and/or metal material, such as titanium. These materials can be prohibitively expensive, and manufacturing the dental implants using these materials can be difficult as well. Furthermore, installing these conventional dental implants can be difficult and time consuming.

Accordingly, there remains a need for a dental implant that is less expensive. There also remains a need for a dental implant that can be manufactured more easily. Furthermore, there is a need for a dental implant that can be installed more easily than conventional dental implants.

### SUMMARY OF THE INVENTION

The disadvantages of the prior art are overcome in a dental implant assembly that can be attached to a bone of a person. The implant assembly includes an anchor adapted for attachment to the bone. The anchor is also adapted for attachment to a tooth-replacing device. The anchor is at least partially made out of a polymeric material.

The dental implant assembly can be easier to manufacture and install. Also, the dental implant assembly can be less expensive than those of the related art.

Further areas of applicability of the present disclosure will become apparent from the following detailed description. It should be understood that the detailed description and specific examples are intended for purposes of illustration only and are not intended to limit the scope of the disclosure.

### BRIEF DESCRIPTION OF THE DRAWINGS

The present teaching will become more fully understood from the detailed description and the accompanying drawings, wherein:

FIG. 1 is a sectional side view of one embodiment of a dental implant assembly of the present disclosure;

FIG. 2 is a sectional side view of another embodiment of the dental implant assembly; and

FIG. 3 is a sectional side view of another embodiment of the dental implant assembly.

### DETAILED DESCRIPTION OF THE PREFERRED EMBODIMENTS

The following description is merely exemplary in nature and is in no way intended to limit the disclosure, its application, or uses.

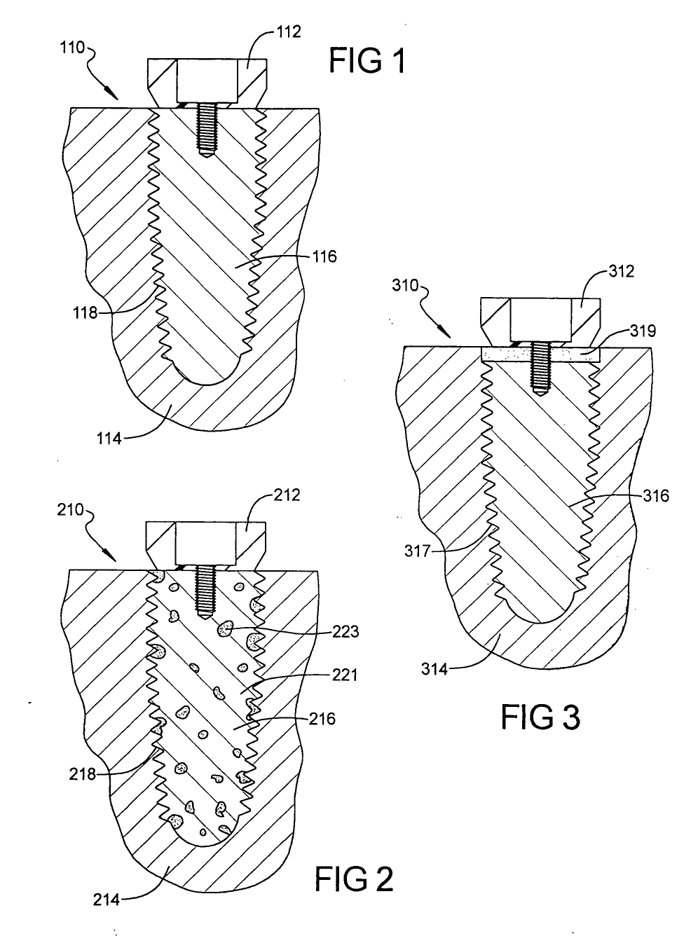

Referring now to the drawings, and in particular, to FIG. 1, one embodiment of the dental implant assembly 110 is shown. The dental implant 110 includes an anchor 116. The anchor 116 is generally cylindrical and defines an outer attachment surface 118. In the embodiment shown, the outer attachment surface 118 is threaded so as to facilitate attachment of the anchor 116 to a bone 114, such as the jawbone. Also, the anchor 116 is generally solid in cross-section in the embodiment shown.

The anchor 116 is further adapted for attachment of a tooth-replacing device 112. For instance, the tooth-replacing device 112 can be attached with a threaded fastener or otherwise to the anchor 116.

The anchor 116 is made at least partially out of a polymeric material, such as polyetheretherketone (PEEK). In the embodiment shown in FIG. 1, the anchor 116 is entirely made out of the polymeric material. Because the polymeric material is used to make the anchor 116, the dental implant assembly 110 can be less expensive. Also, the polymeric material of the anchor 116 makes the dental implant assembly 110 easier to manufacture and easier to install.

Turning now to FIG. 2, another embodiment of the dental implant assembly 210, where like numerals, increased by 100, are used to designate like components with respect to the embodiment shown in FIG. 1. In the embodiment shown in FIG. 2, the anchor 216 is made out of polymeric material and a metallic material, such as titanium and/or hydroxyapetite. More specifically, in the embodiment shown, the anchor 216 includes a matrix 221 of polymeric material, such as polyetheretherketone (PEEK). The matrix 221 is impregnated with a plurality of deposits 223 of a metallic material, such as titanium and/or hydroxyapetite. In one embodiment, the metallic deposits 223 are dispersed throughout the matrix 221 of the anchor 216. In one embodiment, the metallic deposits 223 are disposed primarily on or near the outer attachment surface 218 of the anchor 216. For instance, the polymeric matrix 221 can be coated on the outer attachment surface 218 with the metallic deposits 223 in one embodiment. The polymeric matrix 221 can allow the dental implant assembly 210 to be less expensive to manufacture and easier to install. Additionally, the metallic deposits 223 can facilitate bone growth, especially along the outer attachment surface 218, where the bone 214 is disposed adjacent the metallic deposits 223.

Turning now to FIG. 3, another embodiment of the dental implant assembly 310 is shown, where like numerals, increased by 200, are used to designate like structure with respect to the embodiment illustrated in FIG. 1. In this embodiment, the anchor 316 includes a bottom portion 317 and a collar portion 319. The collar portion 319 is disposed adjacent the tooth-replacing device 312 and is interposed between the tooth-replacing device 312 and the bottom portion 317 of the anchor 316. The collar portion 319 can be coupled to the bottom portion 317 in any suitable manner, such as by press fitting.

In one embodiment, the bottom portion 317 of the anchor 316 is made entirely out of a polymeric material, and the collar portion 319 is made out of a metallic material, such as titanium and/or hydroxyapetite. As such, the anchor 316 can be less expensive to manufacture and install; however, the metallic material of the collar portion 319 promotes tissue growth.

In summary, the dental implant assembly 110, 210, 310 can be easier to manufacture and install. Also, the dental implant assembly 110, 210, 310 can be less expensive than those of the related art.

The description is merely exemplary in nature and, thus, variations that do not depart from the gist of the disclosure are intended to be within the scope of the disclosure. Such variations are not to be regarded as a departure from the spirit and scope of the disclosure.

1. A dental implant assembly that can be attached to a bone of a person comprising:
a one piece anchor adapted for attachment to the bone, and adapted for attachment to a tooth-replacing device, said anchor having a body with an unitary continuous outer wall surface, said outer wall surface having a desired ridge configuration which enables said one piece anchor to be directly attached and secured with a jaw bone;
wherein said one piece unitary anchor is at least partially made out of a polymeric material.

2. The dental implant assembly of claim 1, wherein said anchor is at least partially made out of polyetheretherketone (PEEK).

3. The dental implant assembly of claim 1, wherein the anchor is entirely made out of a polymeric material.

4. The dental implant assembly of claim 1, wherein the anchor is made out of a polymeric material and at least one of titanium and hydroxyapetite.

5. The dental implant assembly of claim 4, wherein the polymeric material is impregnated with the at least one of titanium and hydroxyapetite.

6. The dental implant assembly of claim 4, wherein the anchor includes a bottom portion made out of a polymeric material and a collar portion made out of at least one of titanium and hydroxyapetite.
